(19) United States
(12) Patent Application Publication
(10) Pub. No.: US 2010/0318377 A1
(43) Pub. Date: Dec. 16, 2010

(54) BREAST MILK MANAGEMENT SYSTEM AND METHOD AND ELEMENTS FOR USE THEREWITH

(76) Inventor: Anthony C. Lair, Alpharetta, GA (US)

Correspondence Address: NORA M. TOCUPS, P.O BOX 698, 140 PINECREST AVE, DECATUR, GA, 30030, US

(21) Appl. No.: 12/817,128

(22) Filed: Jun. 16, 2010

Related U.S. Application Data
(60) Provisional application No. 61/187,502, filed on Jun. 16, 2009.

(51) Int. Cl. G06Q 50/00

(52) U.S. Cl. 705/2; 235/375

(57) ABSTRACT

The invention relates to minimizing errors in expressed breast milk feeding in NICU/PICU and other environments. A container of expressed breast milk is labeled with information unique to mother and child. The information may be used to access a system of information about the expressed breast milk, mother's identity, child's identity, location of the breast milk, dates relevant to the breast milk such as express date, receipt, and expiration, and other information such as fortification prior to feeding or feeding by syringe. Other information about the breast milk may be added to the system such as transfer location, use, feeding, disposal, etc. The invention may provide for validation of the identity of the baby to receive the breast milk at the time of feeding, and may also provide for validation at the time of feeding of the container, bottle or syringe as containing the breast milk of the identified mother.

### CROSS-REFERENCE TO RELATED APPLICATION

The present application claims priority to and benefit of the prior filed co-pending and commonly owned provisional application, filed in the United States Patent and Trademark Office on Jun. 16, 2009, assigned Ser. No. 61/187,502, entitled BREAST MILK MANAGEMENT SYSTEM AND METHOD AND ELEMENTS FOR USE THEREWITH, and incorporated herein by reference.

### FIELD OF THE INVENTIONS

The invention relates to extracted breast milk management systems and methods and elements for use therewith. Particularly, the invention relates to systems, methods and elements that may facilitate the identification of extracted breast milk, its storage, and its validated feeding such as may be used in a neonatal intensive care unit/pediatric intensive care (NICU/PICU) environment. Nonetheless, the invention may have application in other environments and with subject matter other than breast milk.

### BACKGROUND

Breast milk is recommended as the optimal source of nutrition for infants. Breast milk contains immune properties that may reduce the risk of morbidity and mortality in neonates. Research has shown that providing mothers' breast milk to premature infants may help reduce the incidence of necrotizing enterocolitis, reduce infection rates, improve feeding tolerance, and improve neuro-developmental outcomes.

Breast milk is classified as a body fluid similar to blood or plasma, and contact with any type of body fluid carries a risk for transmission of infection. The many possible infectious diseases that can be present in breast milk include human immunodeficiency virus (HIV), hepatitis, cytomegalo-virus (CMV), herpes simplex virus (HSV), and methicillin-resistant staphylococcus aureus (MRSA). These agents may cause devastating consequences, especially if the wrong mother's milk is given to an infant. There also may be non-medical consequences if an infant receives breast milk from the wrong mother. These consequences may include psychological stress and induced anxiety in the parents if they think their infant(s) may have contracted a potentially fatal disease. This can lead to a loss of confidence and mistrust in the organization taking care of their infant(s). One study showed that traditional feeding methods reflect a potential for 1.04 errors for every 10,000 feeding opportunities. The site of the study averaged 12,840 feedings per month. See Use of the Six Sigma Methodology to Reduce Incidence of Breast Milk Administration Errors in the NICU, by Douglas Drenckpohl, MS, RD, CNSD, LDN, Laura Bowers, BSN, RN, and Hoa Cooper, MSHSA, RN, published in Vol. 26, No. 3, of the May/June 2007 issue of NEONATAL NETWORK at pages 161-166, which is incorporated herein by reference.

### SUMMARY

Generally stated, the invention relates to management systems for materials such as expressed breast milk where such management systems may include systems, methods and elements relevant to the identification of such materials, their storage, and their use such as in feeding. The inventions are described herein as being used with specific materials, elements and features, but should not be limited to the particular examples given.

Advantageously, implementation of an embodiment of the invention may minimize errors in the feeding process via bottle or syringe of extracted breast milk for an infant. Implementation of an embodiment of the invention may allow for the identification, management, and validation of breast milk for each infant in the care of a facility. The embodiment may be used to store and convey instructions about feedings such as use of a bottle or syringe, fortification, nutrition information, spoilage, disposal, optimal use of expressed milk, etc. A particular embodiment includes a bar code label printer and mobile hand held computer with a bar code scanner and software that may be networked (wirelessly) with other elements such as a database, server, and workstations. This embodiment may be considered user friendly and allows a user to identify and record the receipt of each milk container, locate it, use it before expiration, and make sure it is validated before used for a feeding. This exemplary embodiment also may provide documentation of each feeding for record proof of the correct feeding. By using real time bar code technology at crib side, one nurse can safely feed an infant, which may result in more efficient work patterns in the ward, which in turn, may result in cost savings.

Other features and advantages of the inventions may be more clearly understood and appreciated from a review of the following detailed description and by reference to the appended drawings and claims.

### BRIEF DESCRIPTION OF THE DRAWINGS

FIG. 1 is a flow diagram of an exemplary embodiment of the invention.

FIG. 2 is a flow diagram of an exemplary embodiment of the invention.

FIG. 3 is a block diagram of a system that may be used in whole or in part to implement an exemplary embodiment of the invention.

FIG. 4 depicts three examples of bottles as may be used with an exemplary embodiment of the invention.

FIG. 5 depicts 5 labels as may be used with an exemplary embodiment of the invention.

FIG. 6 depicts a syringe with an affixed label as may be used with an exemplary embodiment of the invention.

### DETAILED DESCRIPTION

The invention is described herein with reference to exemplary embodiments, alternative embodiments, and also with reference to the attached drawings. The invention, however, can be embodied in many different forms and carried out in a variety of ways, and should not be construed as limited to the embodiments set forth in this description and/or the drawings. The exemplary embodiments that are described and shown herein are only some of the ways to implement the inventions. Elements and/or actions of the inventions may be assembled, connected, configured, and/or taken in an order different in whole or in part from the descriptions herein.

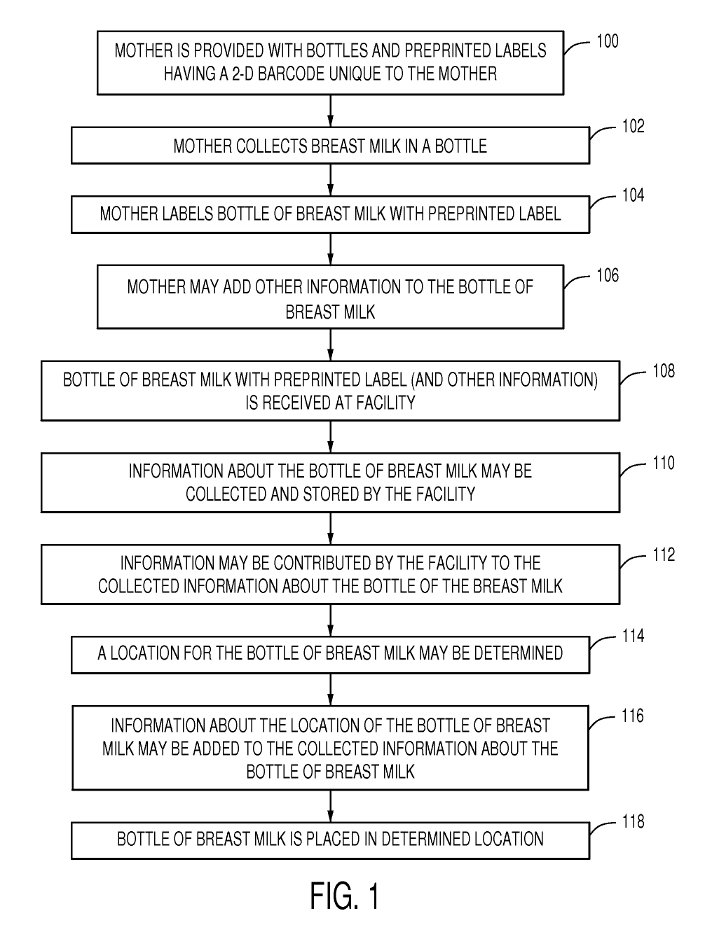

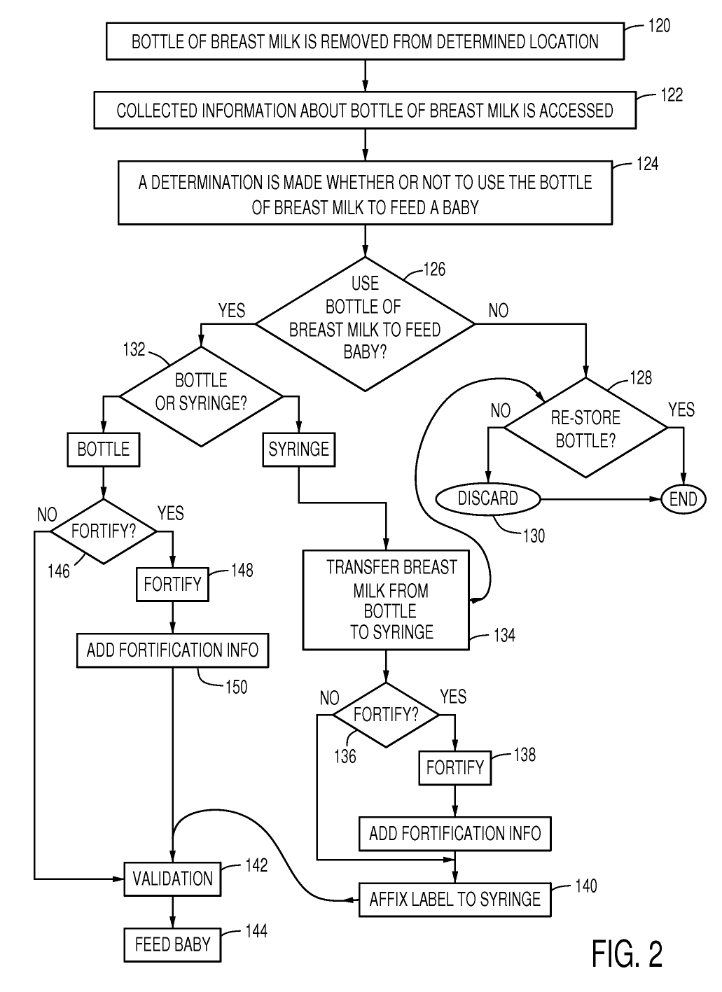

Generally stated, the invention relates to systems such as may be embodied in an extracted breast milk management system and methods and elements for use therewith. An overview may be gained from a review of the flow diagrams of FIGS. 1 and 2, which provide, with this description, a summary example of the invention with reference to a mother who provides extracted breast milk to a facility for feeding to her newborn, who is a patient in the facility.

Initially, in action 100 of FIG. 1, the mother may be provided with bottles and labels. The bottles are for use in the collection of the mother's breast milk. Such collection of breast milk also may be referred to as “extraction” or “expression”. As is described in further detail below, the bottles include may advantageous features and may be used with breast pumps. The labels may be printed with information unique to the mother and her child (“unique information”). For example, the labels may be preprinted with a barcode (such as a two dimensional (2-D) barcode) that represents information unique to the mother. Such unique information may include an identification number assigned to the mother (and/or her child) by the medical facility. The unique information may include other details such as the mother's name, the name of the child who is a patient in the medical facility, etc.

In some cases, the mother may be provided with bottles already having the preprinted labels affixed, and in other cases, the mother may have to affix the preprinted labels, and yet in other cases, the unique information may need to be added by the mother to the labels (whether or not the labels are already affixed on the bottles).

In action 102 of FIG. 1, the mother collects her breast milk in one of the bottles. Either previously or after extracting the breast milk into the bottle, in action 104 the mother affixes a label with the unique information to the bottle, if the label is not already affixed. In action 106, the mother may add other information relating to the collected breast milk. This other information may be added by the mother directly such as by writing on the bottle (in a designated location or not), by adding the other information to the label with the unique information, and/or by adding another label with the other information to the outside of the bottle with the collected breast milk (and/or otherwise). Typically, this other information may include the date and time relating to the collection of the breast milk. The other information also may include a notation of medications, vitamins, and so on consumed by the mother, etc.

In action 108, the bottle with the collected breast milk is received by the medical facility. As noted above, the bottle includes the affixed label with the unique information and may include other information relating to the breast milk in the bottle. The medical facility may follow a procedure of collecting data relevant to each bottle of breast milk received. Data about the breast milk in the received bottle may be collected by the medical facility throughout the breast milk's history from its receipt to its ultimate disposition. Access to the “collected data” about a particular bottle of breast milk at the medical facility may be gained in a number of ways, but access is made convenient by reference to the label with unique information on the breast milk bottle. The label with unique information may be scanned by a person at the medical facility, and that person then would have access to all the data collected about the breast milk in the bottle.

Referring again to FIG. 1, in this example, as part of collecting the data on the breast milk in the bottle as shown in action 110, the medical facility may scan and/or otherwise obtain the information from the label with the unique information on the bottle. The medical facility also may obtain the other information, if such other information has been added to the bottle by the mother (and/or other). As shown in action 112, in addition, the medical facility may contribute information to the collected data about the breast milk in the bottle. For example, the medical facility may contribute information such as the date of receipt of the bottle of breast milk, its expiration date (or date/time), its status (frozen or fresh), etc. to the collected data. The contributed information also may include instructions such as the need to fortify the breast milk prior to its use in feeding. The contributed information also may include instructions on how to feed such as by syringe or by bottle. Other contributed information may include the name of the physician of the patient, emergency information, etc. This contributed information (in whole or in part) may (or may not) be added so it is also visible on the received bottle as well as contained as part of the data collected about the bottle of breast milk.

In action 114 of FIG. 1, the medical facility may use the collected data (or not) to determine a location for the received bottle. In some cases, the location may be predetermined. In action 116, information about the location may be added to the data collected about the received bottle of breast milk. In some embodiments, a location label may be printed and affixed to the received bottle of breast milk. For example, the location label may include the storage location for the breast milk bottle. The location label may (or may not) include information besides location information. In action 116, the medical facility causes the received bottle of breast milk to be placed in its location.

When the breast milk is needed (and/or at other times), the bottle may be removed from its determined location as noted in action 120 in the flow diagram of FIG. 2. In action 122, the label with the unique information may be scanned and/or otherwise reviewed to access the collected data about the breast milk in the bottle. In actions 124, 126, a determination may be made based on the accessed collected data or contributed data as to whether or not to use the breast milk to feed the baby identified by the data. For example, a medical facility may follow a “first in/first out” policy with respect to breast milk. So, a bottle of breast milk which was received earlier than another bottle (from a particular mother for a particular patient) may be used prior to the later received bottle. As another example, the collected data may reveal that the breast milk in a specific bottle has reached its expiration date/time, and thus should not be used.

If the bottle is not to be used for feeding the patient, then in action 128 a determination may be made as to whether to return the bottle to its storage location. This determination may be made on information contained in the collected information relating to the breast milk in the specific bottle (or other information). If the determination is positive, then the bottle is returned to its storage location. This exemplary process then may return to action 120 to remove another bottle from its storage location and continue the process (and/or take other action). If the bottle is not to be returned to its storage location, then in action 130 the bottle (and/or its contents) may be discarded and/or otherwise disposed of. Other exemplary processes may have other and/or additional actions with respect to a bottle that is not to be returned to its storage location.

Refer again to the determination in action 124,126 as to whether to use the breast milk in the bottle removed in action 120 to feed the patient. If the determination is positive, then another decision may need to be made in action 132 as to whether the patient may be bottle-fed or pump fed by use of a syringe. The information for this determination may be (but does not have to be) included as part of the data collected by the facility with respect to the bottle of breast milk or determined otherwise.

If the determination is that the patient is to be bottle-fed, then as shown in action 146 another determination may need to be carried out. As noted above, the data collected about a bottle of breast milk may include instruction relating to fortification of the milk. In action 146 of FIG. 2, a fortification determination is carried out such as by reference to the collected data. If the determination is positive, then in action 148 fortification may be carried out. In action 140, fortification information may be added to the data collected about the breast milk in the bottle.

After actions 148, 150 if fortification is to be carried out, or if the determination in action 146 is that no fortification is necessary, then the bottle may be delivered to the feeding location. Information about the transfer of the bottle from its storage location to its use in feeding the patient may be added so the transfer information is included in the data collected about the bottle of breast milk. Thus, a person searching for this particular bottle of breast milk (and/or information about it) may be apprised of the bottle's location at the feeding site by accessing the data collected about the bottle of breast milk.

Prior to using the bottle to feed the patient, the facility may cause its personnel to validate the identity of the patient and also to validate that the particular bottle of breast milk is to be used for feeding the identified patient as shown in action 142. The instructions for validation may be “standard procedure” or may be included in the collected information about the breast milk in the received bottle. The label with the unique information on the bottle of breast milk may be scanned or otherwise used to access the data collected about the bottle of breast milk to carry out the validation between patient and bottle of breast milk. If the validation is successful, the bottle may be used to bottle-feed the patient. If the validation is unsuccessful, the bottle is not used to feed the patient. Other steps may follow an unsuccessful validation.

Once the patient is fed with the breast milk in the bottle, further information may be added to the data collected about the bottle of breast milk. For example, the data collected about the bottle of breast milk may include a notation of its use in feeding the patient. The notation might include the date/time of feeding, how much was consumed, where it was used, disposition of the bottle (with or without remaining breast milk), etc.

Refer again to the determination in action 132 in FIG. 2 as to whether the patient is to be bottle-fed or pump fed by use of a syringe. If the patient is to be pump fed, then at least some of the breast milk from the bottle may be transferred from the bottle to a syringe as indicated by action 134. If there is breast milk remaining in the bottle after transfer of some of the breast milk to the syringe, the bottle with the remaining breast milk may be returned to its storage location. See action 128 et seq. Information about the remaining breast milk in the bottle and/or the return of the bottle to the storage location may be added so that information about the remaining (and/or removed) breast milk is included in the data collected about the bottle of breast milk.

In addition, information about the transfer of the breast milk from the bottle to the syringe may be included as part of the data collected about that bottle of breast milk. Thus, a person seeking information about the history of the breast milk in that bottle might read from the collected data about the transfer of at least some of the breast milk to a syringe, about the remaining amount of breast milk in the bottle, and/or about the bottle's storage location as well as other collected data.

As noted above, the data collected about a bottle of breast milk may include instruction relating to fortification of the milk. In action 136 of FIG. 2, a fortification determination is carried out such as by reference to the collected data. If the determination is positive, then in action 138 fortification may be carried out. In action 140, fortification information may be added to the data collected about the breast milk in the bottle.

As part of the transfer of some of the breast milk from the bottle to the syringe, a label may be printed for placement on the syringe. The label may include information unique to the mother and the patient for whom the breast milk is intended. For example, the label may be printed with a barcode (such as a two dimensional (2-D) barcode) that represents information unique to the mother. Such unique information may include an identification number assigned to the mother (and/or her child) by the medical facility. The unique information may include other details such as the mother's name, the name of the child who is a patient in the medical facility, etc. The unique information on the label for the syringe may compare to the unique information on the label affixed to the bottle of breast milk from which the breast milk was drawn for the syringe. In addition to the unique information, the label on the syringe may include information relating to the breast milk that was transferred from the bottle to the syringe. Such additional information may include the amount of breast milk transferred, the date/time of transfer, the amount remaining in the bottle, the expiration date of the breast milk transferred to the syringe, the storage location of the bottle, the location of the patient, fortification, disposal, etc. In action 140, the label may be affixed to the syringe.

The syringe with the breast milk may be delivered to the patient for feeding. Information about the transfer of the syringe for its use in feeding the patient may be included in the data collected about the bottle of breast milk. Thus, a person searching for a particular bottle of breast milk (and/or information about it) could access the data collected by the facility relating to that bottle. The searcher would be apprised by the data collected of the transfer of some amount of the breast milk from the bottle to the syringe, and also would be apprised of the syringe's location at the feeding site (and/or other information).

Prior to using the syringe to feed the patient, as shown in action 142 of FIG. 2, the facility may cause its personnel to validate the identity of the patient and also to validate that the syringe of breast milk is to be used for feeding the identified patient. The label on the syringe of breast milk may be scanned or otherwise used to access the data collected about the bottle of breast milk to carry out the validation between patient and syringe of breast milk from that bottle. If the validation is successful, the patient may be pump fed with the syringe of breast milk as shown in action 144. If the validation is unsuccessful, the patient is not fed with the breast milk in the syringe. Other steps may follow an unsuccessful validation.

Once the patient is fed with the breast milk using the syringe, further information may be added to the data collected about the bottle of breast milk. For example, the data collected about the bottle of breast milk may include a notation of use of part of the breast milk in a syringe in pump feeding the patient. The notation might include the date/time of feeding, how much was consumed, where it was used, what happened after feeding, etc.

The example provided above in connection with FIGS. 1 and 2 refers to entities and elements such as a mother, newborn, child, baby, patient, medical facility, breast milk, bottles, labels, etc. These entities and elements are used by way of example only. Other entities and elements may be substituted in accordance with the principals of the invention. For example, there may be a care-giver in the role of a mother rather than a birth mother for a child, a child receiving extracted breast milk from his or her mother does not necessarily have to be a newborn, and the facility feeding the child may be an institution other than a medical facility. Other substitutions are possible and the invention should not be limited by the examples provided. All terms should be broadly interpreted unless otherwise noted.

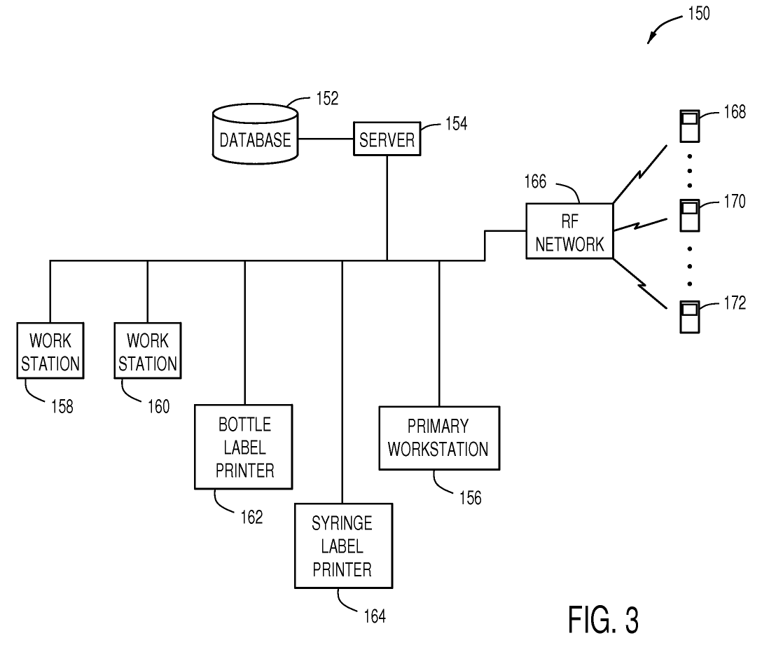

FIG. 3 is a block diagram of an exemplary system 150 as may be used to implement all or part of an exemplary embodiment(s) of the invention. For example, a medical facility may implement a networked system as shown in FIG. 3. Alternatively, the medical facility may implement the functionality of one or more of the elements of the system 150 into an existing network of the facility. The facility may store information such as the collected (or other) information about a received bottle of breast milk in a database 152 that may be accessed and manipulated through a server 154.

A primary workstation 156 and other exemplary workstations 158, 160 may connect to the server 154. Fewer or more workstations may be included. A workstation may be used to input information about a particular patient and his or her breast milk feedings. A workstation may be used to identify and record the receipt of each milk container, locate it, use it before expiration, and make sure it is validated before used for a feeding.

A bottle label printer 162 and a syringe label printer 164 may be connected to the system 150. These printers 162, 164 may include bar code printing capability. In other embodiments, a conventional printer may handle the printing of bottle labels or syringe labels, or both. Alternatively, one printer may be dedicated to the printing of both kinds of labels. The elements so far mentioned with reference to FIG. 3 may be individually or as part of the networked system 150 connected through an RF (radio frequency) network 166 to handheld units 168, 170, 172.

Three handheld units are shown in FIG. 3; more or fewer (or none) handheld units may be used in other embodiments. A handheld unit may be a mobile hand held computer with a bar code scanner and appropriate software. A handheld unit may connect through the RF network 166 to other elements in the system 150. As the term implies, a handheld unit may be carried by a medical provider in the exemplary hospital example. A handheld unit may be used for many of the same actions as a workstation as described in the paragraphs above. A handheld unit may be particularly useful in validation at the place of feeding.

The exemplary system 150 shown in FIG. 3 may be used to identify, manage, and validate the milk for each infant in the care of the medical facility.

The example described above with reference to the flow diagrams of FIGS. 1 and 2 refer to a bottle used for the collection of extracted breast milk. The bottle also may be referred to as a “container”. A container according to an exemplary embodiment of the invention may be and/or have one or preferably more of the following characteristics:

transparent;

sterilized other than by ETO gas sterilization;

measurement lines;

screw-on compatibility with breast pump;

snap-on attached cover;

specific identifier such as optical machine-readable representation of data (barcode such as 2-D barcode) (also referred to as “label with unique information”);

general identifier such as enteral color (orange) label;

space for additional information by way of label attachment and/or otherwise;

ease of use without contamination of breast milk;

easy to store;

compatible with breast pumps;

safe for collection, storage, and feeding of breast milk; and

BPA/DEHP free.

Advantageously, a container according to the invention may be used as part of a breast milk management system or method to help reduce or prevent potential errors associated with the administration of expressed breast milk.

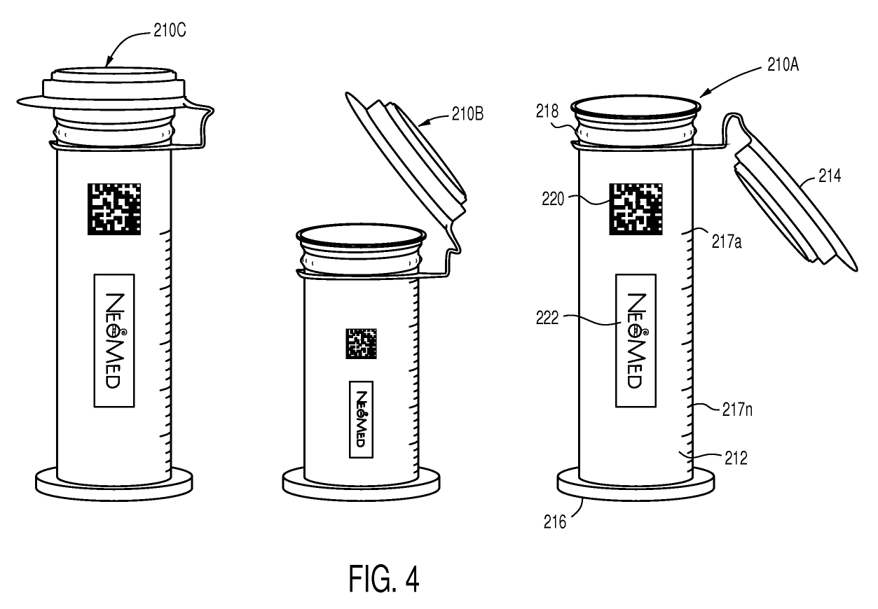

FIG. 4 shows three exemplary embodiments 210A-C of a container according to the invention. All three containers are generally configured in the same way. Containers 210A and 210C are the same except container 210A is open while container 210C is closed. Containers 210A and 210C are referred to as two ounce (2 oz) size containers, while container 210B is a one ounce (1 oz) container. The exemplary containers 210A-C are manufactured by Capitol Vial, Inc., 2039 McMillan Street, Auburn, Ala., as SNAPPIES® containers. The containers 210A-C shown in FIG. 4 are examples. The invention may be embodied in other ways including containers of different sizes, shapes, materials, and/or other characteristics.

Generally stated, each of the exemplary containers 210A-C is made of food-grade polypropylene, which will not bind or hold milk fat during storage, and which does not contain PVC, DEHP, latex, or bisphenol A. But as noted, other materials as appropriate may be used in the alternative or in part.

The exact size of the containers 210A-C is not necessarily important so long as the size is appropriate for use. In FIG. 4, containers 210A, C are generally cylindrical, and about 4.5 inches in height with an interior diameter of about 1.25 inches.

Additional details regarding an exemplary embodiment of the invention are now provided with reference to container 210A. The container 210A includes a generally cylindrical body 212 with a tethered snap-on cap 214. The cap 214 allows for substantially complete containment of materials inside the container 210A, and also allows for ready access to the contents. The top of the cap 214 and the bottom 216 of the container 210 are generally flat. The container 210a may be stood for storage or otherwise on its flat bottom 216.

Referring to the exemplary container 210, its cap 214 is tethered or attached (integrally or otherwise) to the cylindrical body 212 of the container 10. Other embodiments may have caps that are different in configuration, that attach in different ways, and/or that may be made to attach in different ways. Alternatively, other embodiments may have caps or covers that are completely separate until they are used to cover and contain the contents in the container. Also, the exemplary cap 214 may be referred to as a “snap-on” or “flip top” cap in that the exemplary cap 214 may be easily and selectively fitted securely to cover the top of the cylindrical body 212 of the container 210. Other embodiments may have caps that cover and/or fix onto the tops of the bodies of the containers in other ways, or may be made to cover and/or fix onto the tops in other ways.

The exemplary container 210 is substantially completely transparent but for the elements described below. In other words, a user may see the contents of the container 210 generally through the cylindrical body, the cap 214, or the bottom 216. Other embodiments may be other than substantially completely transparent.

Advantageously, a user may take note of the amount of the contents of the container 210 (if any) by reference to the measurement marks 217a-217n that may be molded, raised, silk-screened, and/or otherwise marked on the outside the body 212 of the container 210. In other words, the exemplary container 210 is graduated or marked on the outside with lines indicating volume. In this example, the marks 217a-217n are somewhat raised above the surface of the container 210 and are substantially translucent. In another embodiment, the measurement marks may other than substantially translucent. For example, the marks may be all the same shade of orange to signify use with enteral systems or in NICU/PICU environments. The exemplary container 210 also includes a second set of measurement marks (not shown in FIG. 1) that provide indication of volume in milliliters. In this example, the milliliters marks are also substantially translucent, but do not have to be in other embodiments.

The substantial transparency of the exemplary container 210 and substantial translucency of its measurement marks 217a-217n may facilitate the work or process of adding fortification to the contents of the container 210. Fortification may include the addition of vitamins and minerals (and/or other) to the breast milk. As noted, the exemplary container 210 facilitates the addition of fortification. For example, assume a particular patient is to receive fortified extracted breast milk from his or her mother. Medical personnel may add fortification to the breast milk in the exemplary container 210. From the transparency of the container 210 and the measurement marks 217a-217n, the medical personnel can check easily whether the appropriate amount of fortification has been added.

Prior to use, the exemplary container 210 may be sterilized at least inside. Preferably, the sterilization is carried out in a manner other than the use of ethylene oxide gas (ETO) sterilization. ETO sterilization may leave undesirable residue in the container 210. Gamma ray sterilization may be used to sterilize the exemplary embodiment 210.

As noted initially, the exemplary embodiment may be used as part of a breast milk management system or method to reduce or prevent errors associated with the delivery of expressed breast milk. For example, the exemplary container 210 may be used with a breast pump to receive extracted or expressed breast milk. The top 218 of the cylindrical body 212 of the container 210 may be threaded so the container 210 may be screwed onto a breast pump. An exemplary breast pump with which the exemplary container 210 may be used is a Hollister or Madela breast pump. Other embodiments may be compatible with other types of breast pumps, and/or may attach to a breast pump in a different way. Alternatively, an embodiment does not necessarily have to be used with a breast pump but may receive extracted breast milk in another manner.

The exemplary container 210 includes an identifier 220 that may be used to access information about the container 210. The identifier 220 may be a 2-D bar code such as the generally square 2-D bar code 220 as shown in FIG. 4. Each side of the exemplary 2-D bar code 220 is slightly longer than half an inch. The identifier 220 may identify the container 210 by its size, type, product number, product code, product description, manufacturer, etc. The same identifier 220 may present on all containers of the same size, type, manufacturer, etc. In this embodiment, the identifier 220 is orange in color, which may aid at least in the quick identification of the container as an enteral use container and/or in NICU/PICU environments. An identifier having different characteristics (other than or in addition to the generally square 2-D bar code 220 shown in FIG. 4) may be used with other embodiments.

The exemplary container 210 also includes an identification block 222. In this embodiment, the identification block 222 is shaped as a generally elongated rectangle with its longer sides generally parallel to the vertical axis of the substantially cylindrical container 210. The identification block 222 is located substantially directly below, but spaced slightly apart from and generally in parallel with the 2-D bar code identifier 220. The exemplary identification block 222 is about 7/16^{th} of an inch on its short sides and about 1.5 inches on its long sides. The block 222 is substantially orange in color but for the substantially transparent letters (spelling out NEOMED INCORPORATED) etched into the orange block 222. In other words, the orange block 222 has a stencil like appearance with respect to the name of the source of the bottle—NEOMED INCORPORATED. Other embodiments may have identification blocks having different characteristics and/or placement. The identification block 222 is referred to as such because it allows a user to quickly identify the container 210 as a bottle typically used for extracted breast milk in an enteral system and/or NICU/PICU environments based on the orange color.

An exemplary container also may include an area on its barrel designated for direct receipt of information. For example, in an embodiment, a container may have a designated area for the name of the mother and/or baby, and date/time of extraction of breast milk. The designated area may be indicated by silk screening, by a raised surface molded on the barrel, and/or otherwise. A mother may add information by writing in the designated area on the barrel of the container.

Further, an exemplary container according to the invention may include a designated location on the outside of the barrel of the container for the affixation of one or more labels as described below and also as referred to as personalized labels.

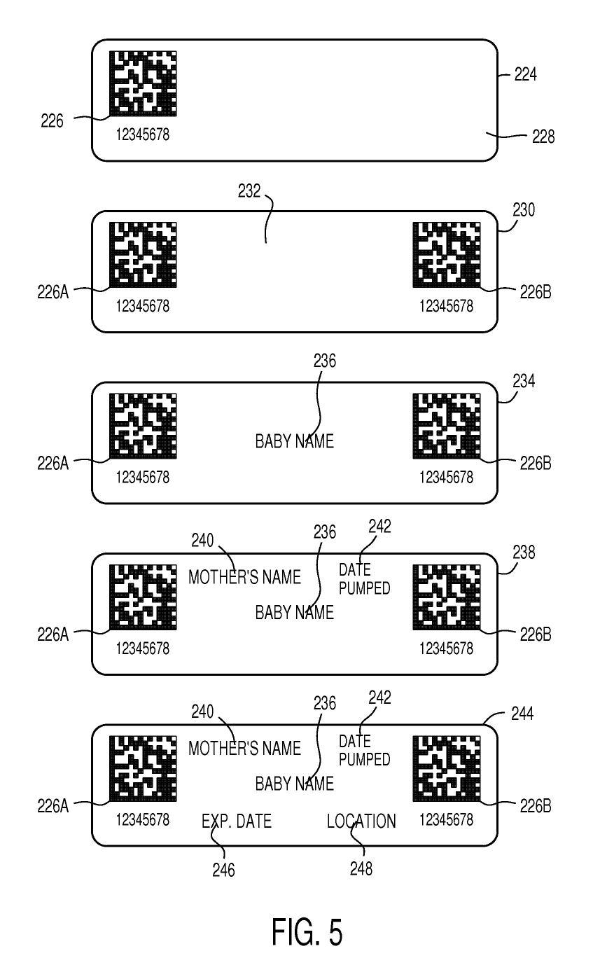

As explained above in connection with the flow diagrams of FIGS. 1 and 2, an exemplary embodiment of the breast milk management system and method may provide a mother with bottles and labels, or just labels. The bottles are for use in the collection of the mother's breast milk. Exemplary bottles have been described above. Exemplary labels are described below in connection with FIG. 5.

As used herein, the term “label” refers to a piece of paper (plastic, and/or other material) that may be affixed to the outside of a container of breast milk. Information may be printed and/or otherwise included on the label so the information may be scanned and/or read. In addition, however, the information described as printed or included on the exemplary labels of the invention may be printed or included directly on the containers of breast milk. For example, the information mentioned below as included on a label may be silk screened (all at once, or each piece of information separately or in combo) or may be added by marker (or otherwise) on a container of breast milk.

As noted above, a mother may be provided with bottles and labels or labels. The labels may be provided to a mother separately from the bottles. A mother may be provided with more labels than bottles or vice versa. A label may be pre-fixed to each bottle a mother receives, or a mother may have to affix the labels to the bottles. Additional labels may or may not be provided to the mother if she receives bottles with labels respectively prefixed thereon. The term “mother” is used herein interchangeably with the appropriate person and/or entity who and/or what carries out the function(s) mentioned.

FIG. 5 illustrates five examples of labels as may be used with the inventions. All five examples are of substantially the same size and shape, but this does not have to be the case. Each of the five examples is shaped generally as a rectangle with a label being almost four times wider than it is tall. The precise size of a label (as well as many of its other characteristics) is not important so long as the particular label interfaces appropriately with the container with which the label is to be used. For example, a label that is very large with respect to the container with which the label is used may defeat or at least diminish some of the advantages provided by the container. A too large label may obscure at least part of the substantial transparency of the container so that the contents are not easily viewed.

Generally, all five examples of labels have a white or other substantially opaque background so the information on the labels is easily visible and/or differentiated from other information on the containers. The labels, however, may have completely or partially different backgrounds. For example, a label may be wholly transparent in background.

Further, each type of label below is described as a unitary whole, but this does not have to be the case. A label may be composed of one or more parts that may be separately used or combined in any appropriate combination.

According to an exemplary embodiment of the invention, a label (such as one of the five types of labels described below or otherwise) may be affixed to a container for breast milk in any appropriate manner and in any appropriate place on the container. Generally, in the embodiments shown herein, the wide rectangular shape of the five types of labels mentioned below are likely to be affixed in a sideways fashion to containers such as shown in FIG. 4. In other words, the longest sides of a label would be generally parallel to the vertical central axis of the cylindrical container when the label is applied to the container. A container used in accordance with the invention may have a pre-designated place for location of the label or not. The pre-designated place may be indicated in any number of ways or not indicated.

The five examples of labels in FIG. 5 differ from each other in the amount and type of information contained. These five examples are provided for illustrative purposes. Other combinations of amount and/or type of information may be used in other embodiments of labels and/or the inventions.

The first exemplary label 224 includes information unique or at least particular to the mother and/or her child (“unique information”) 226. The term “unique” is used herein to differentiate the mother (or child or element, etc.) from others in the same general environment.

In this example, the unique information 226 is a 2-D bar code that represents information particular to the mother in the environment so as to set her apart from others. Such unique information may include an identification number assigned to the mother (and/or her child) by the medical facility. The unique information may include other details such as the mother's name, the name of the child who is a patient in the medical facility, etc. The unique information may be used to access the data collected by the medical facility (and/or other entity) about that particular container of breast milk. As noted, the facility may keep collecting data about a particular container of breast milk from its receipt through its disposal, and the facility may keep this collected data indefinitely. The collection of that data and access to it may be facilitated by the use of the unique information in the form of the 2-D bar code in the exemplary embodiment.

In the first label 224, the unique information 226 takes up less than one-fourth of the space on the remainder. The remainder of the space on the label 228 may be used for other information that may be added later by the mother, the facility receiving the breast milk, and/or by others. Of course, the exemplary containers used with the invention may include space (other than that designated for a label or otherwise) for a mother (and/or other) to add information. As an example, a mother may use a marker to write information directly on the container in designated areas or not.

The second exemplary label 230 also includes information unique to the mother and/or her child, but in this second label, the unique information is duplicated 226A, 226B on either side of the label 230. Advantageously, the duplication of the unique information 226A, 226B on either side of the label 230 makes it easier to retrieve the unique information. A scanner make pick up the unique information from either of the places 226A, 226B on the label. Even though the unique information is duplicated on the label 30, there may remain at least half of the label 232 that may be used for other information that may be added later by the mother, the facility receiving the breast milk, and/or by others.

The third exemplary label 234 is similar to the second label 230 in that the third label also includes the duplicated unique information 226A, 226B on either side of the label 234. In addition, the third label 234 includes the baby's name (and/or other name or other additional information or data) 236. The baby's name 236 may be included in an easy to read format at least compared to the unique information 226A, 226B that presumably includes information at least for accessing the baby's name, but that unique information 226A, 226B may not be readily read by a person.

Labels such as the third type of label 234 (including the duplicated unique information 226A, 226B and the baby's name 236) may be provided to the mother separately or already prefixed on the bottles by the facility. The facility usually has all of the information that is included on the third type of label 234. Even with the addition of the baby's name 236 to the third type of label 234, there remains space on the label 234 that may be used for other information that may be added later by the mother, the facility receiving the breast milk, and/or by others.

The fourth exemplary label 238 also includes the duplicated unique information 226A, 226B on either side of the label 238 and the baby's name (and/or other name or other additional information or data) 236. In addition, the fourth exemplary label 238 includes the mother's name 240 in an easy to ready (by a person) format. Labels including the duplicated unique information 226A, 226B, the baby's name 236, and the mother's name 240 may be readily provided to the mother separately or already prefixed on the bottles by the facility because all of that information is typically known or available to the facility.

The fourth type of label 238 further includes information 242 on the date the breast milk in the container was pumped. The date pumped information 242 is generally provided in an easy to read (by a person) format. For convenience, the facility providing the mother with labels might provide the mother with the fourth type of labels including prospective dates so that the mother would choose the appropriate dated label to affix to the container of extracted breast milk. In other words, if a mother pumped breast milk into a container of Apr. 18, 2009, she would choose a label to use with that container that indicated that Apr. 18, 2009 was the dated pumped 242. There remains space on the fourth type of label 238 that may be used for other information that may be added later by the mother, the facility receiving the breast milk, and/or by others. For example, the mother might add the time of the breast milk extraction on the Apr. 18, 2009 label provided to her.

The fifth exemplary label 244 includes the same information as the fourth type of label 238 plus data referred to as facility information 246, 248. This data is referred to as facility information generally because it is added by the facility receiving the container of breast milk. Thus, a mother typically would not receive labels with facility information 246, 248 on them. Instead, such facility information generally is added to the labels after they are received by the facility.

In this example, there are two kinds of facility information: expiration date 246 and location 248. Nonetheless, facility information could include one or the other (and/or other information). Expiration date 246 refers to the date by which the breast milk in the container is to be used. The facility may calculate the expiration date 246 based on information received from the mother (and/or otherwise). The expiration date 246 may include a reference to time as well as date. Location information 248 is information on the storage location in the facility of the container of breast milk. The facility information 246, 248 may be added to the label 244 in an easy read (by a person) format so that a medical provider may easily see an expiration date or location for the container of breast milk, even though all of this information may be available in the records of the medical facility and may be accessed simply by scanning the unique information 226A, 226B in the form of the 2-D bar code. There may remain space on the fifth type of label 244 that may be used for other information that may be added later by the mother, the facility receiving the breast milk, and/or by others. The labels shown in FIG. 5 may be used on the containers shown in FIG. 4.

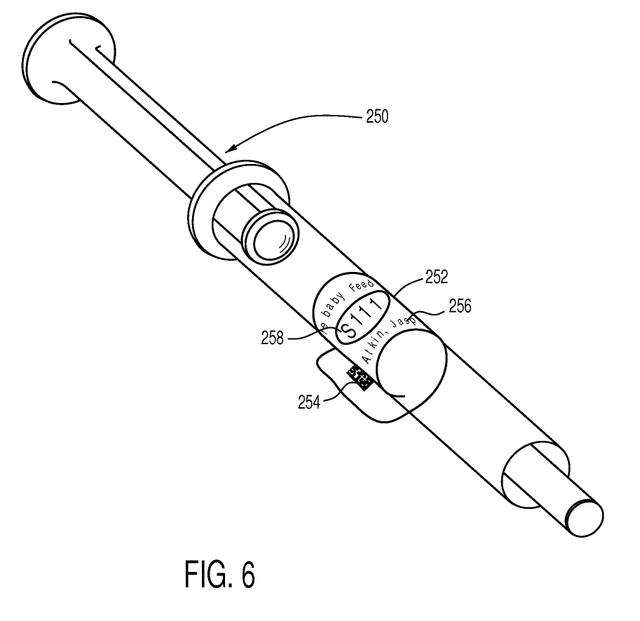

FIG. 6 illustrates a syringe 250 as may be used in feeding breast milk to an infant according to an embodiment of the invention. An exemplary label 252 as may be used with an embodiment of the invention is affixed to the syringe 250. In this example, the label 252 is affixed generally centrally around the circumference of the syringe 250. Other ways of placement of the label are possible. The label 252 may have been generated by a syringe label printer such as mentioned in connection with FIG. 3 or a handheld unit also mentioned in connection with FIG. 3. Generally, a label is prepared and affixed by personnel of the medical facility at the time of use of the syringe for feeding breast milk via the syringe to an infant.

The exemplary label 252 may include information unique or at least particular to the mother and/or her child (“unique information”) 254. The term “unique” is used herein to differentiate the mother (or child or element, etc.) from others in the same general environment.

In this example, the unique information 254 is a 2-D bar code that represents information particular to the mother in the environment so as to set her apart from others. Such unique information may include an identification number assigned to the mother (and/or her child) by the medical facility. The unique information may include other details such as the mother's name, the name of the child who is a patient in the medical facility, etc. The unique information may be used to access the data collected by the medical facility (and/or other entity) about that particular container of breast milk. As noted, the facility may keep collecting data about a particular container of breast milk from its receipt through its disposal, and the facility may keep this collected data indefinitely. The collection of that data and access to it may be facilitated by the use of the unique information in the form of the 2-D bar code in the exemplary embodiment.

The exemplary label 252 includes other information such as the name 256 of the infant (“Atkins, Jasper”) receiving the breast milk via the syringe 250. In addition, the label 252 includes identification information (“S111”) 258 that may pertain to the feeding of the breast milk via syringe to the infant.

The exemplary embodiments of the invention were chosen and described above in order to explain the principles of the invention and its practical applications so as to enable others skilled in the art to utilize the inventions including various embodiments and various modifications as are suited to the particular uses contemplated. The examples provided herein are not intended as limitations of the present invention. For example, all of the examples refer to use of the embodiments with infants. Uses on other persons than infants may be appropriate. Other embodiments will suggest themselves to those skilled in the art. Therefore, the scope of the present invention is to be limited only by the claims below.

I claim:

1. A method for minimizing errors in feeding breast milk of a mother to her child, comprising:
causing the mother to be provided with a bottle, the bottle bearing information unique to the mother and to the child, and the bottle for collecting the breast milk of the mother for the child;
in response to the bottle with the unique information being at least partially filled with the breast milk of the mother for the child, storing the unique information from the bottle;
determining a location for storage of the bottle; and
storing location information relating to the bottle in association with the stored unique information,
whereby the location of the bottle may be determined thereafter by reference to the stored unique information.

2. The method of claim 1, further comprising:
storing other information about the bottle in association with the stored unique information.

3. The method of claim 2, wherein the other information comprises a date on which the bottle was at least partially filled with the breast milk.

4. The method of claim 1, further comprising:
determining contribution information relating to the bottle at least partially filled with the breast milk; and
storing the contribution information in association with the stored unique information.

5. The method of claim 4, wherein the contribution information comprises a date on which the bottle was received.

6. A method for reducing errors in administration of expressed breast milk, comprising:
causing a label to include information identifying an expresser of breast milk;
providing the label for affixing to a container containing expressed breast milk of the expresser; and
collecting and saving the information from the affixed label,
whereby the expresser of the breast milk contained in the container is identifiable from the saved information.

7. The method of claim 6, further comprising:
causing the identification on the label to identify a recipient for the breast milk expressed by the expresser,
whereby the recipient for the breast milk contained in the container is identifiable from the saved information.

8. The method of claim 6, further comprising:
causing the identification on the label to serve as a key to access other information relating to the container containing the expressed breast milk.

9. A method for minimizing error in providing nutrition to a patient, comprising:
using data affixed to a container containing the nutrition to access stored information about the nutrition;
determining from the stored information that the nutrition in the container with the affixed data is to be provided to the patient; and
providing the patient with the nutrition from the container having the affixed data.

10. The method of claim 9, further comprising:
prior to providing the patient with the nutrition from the container having the affixed data, determining from the stored information that usability of the nutrition has not expired.

11. The method of claim 9, further comprising:
determining from the stored information that the nutrition in the container is to be fortified prior to being provided to the patient;
fortifying the nutrition in the container; and
providing the patient with the fortified nutrition from the container having the affixed data used to access the stored information.

12. The method of claim 11, further comprising:
causing information about the fortification to be associated with the stored information about the nutrition in the container having the affixed data.

13. The method of claim 9, further comprising:
prior to providing the patient with the nutrition, validating identity of the patient.

14. The method of claim 9, further comprising:
causing information about the providing of the nutrition to the patient to be associated with the stored information about the nutrition in the container having the affixed data.

15. A method to minimize error in using a syringe to feed a baby with breast milk of his or her mother, comprising:
scanning data on a bottle of breast milk to obtain information including identity of the mother and identity of the baby;
determining the information that the baby is to be fed the breast milk using a syringe;
causing an amount of the breast milk to be transferred from the bottle to the syringe; and
causing a label to be affixed to the syringe, the label including identification data for use in accessing the information including the identity of the mother and the identity of the baby; and
prior to feeding the baby the breast milk with the labeled syringe, using the identification data on the label of the syringe to validate the labeled syringe as containing the breast milk of the identified mother.

16. The method of claim 15, further comprising:
also prior to feeding the baby the breast milk with the labeled syringe, validating the identity of the baby as the baby identified in the information including the identity of the mother and the identity of the baby.

17. The method of claim 15, further comprising:
determining from the information including the identity of the mother and the identity of the baby that the breast milk in the labeled syringe is to be fortified.

18. The method of claim 15, further comprising:
storing information about the feeding of the baby with the labeled syringe in association with the information including the identity of the mother and the identity of the baby.

19. The method of claim 15, further comprising:
determining a storage location for the bottle with remaining breast milk;
associating the storage location with the information including the identity of the mother and the identity of the baby; and
storing the bottle with the remaining breast milk in the storage location.
